(19) United States
(12) Patent Application Publication
(10) Pub. No.: US 2009/0035982 A1
(43) Pub. Date: Feb. 5, 2009

(54) Locking device of an electrical connector

(75) Inventors: Li-Sen Chen, Kwei-Shan Hsiang (TW); Hua-Chun Chang, Kwei-Shan Hsiang (TW)

Correspondence Address: Joe McKinney Muncy, PO Box 1364, Fairfax, VA, 22038-1364, US

(73) Assignee: SPEED TECH CORP.

(21) Appl. No.: 12/068,530

(22) Filed: Feb. 7, 2008

(30) Foreign Application Priority Data
Jul. 30, 2007 (TW) 96212460

(51) Int. Cl. H01R 13/627

(52) U.S. Cl. 439/358

(57) ABSTRACT

A locking device of an electrical connector, wherein the electrical connector comprises an insulating housing, a terminal set and a shielding shell. The insulating housing has at least a sidewall thereby confining at least a containing space between the shielding shell and the sidewall. The locking device can be pivotally connected in the containing space by a pivot and be able to swivel with the pivot. The locking device comprises a main body, a locking portion, a spring arm and an operating portion. The main body has a pivot passing through the central part. The locking portion and the operating portion are respectively at the both ends of the main body. The spring arm, bent from the main body, exerts a pre-loading force toward the sidewall of the insulating housing to keep the locking portion of the locking device in a stationary position.

### RELATED APPLICATIONS

This application claims priority to Taiwan Application Serial Number 96212460, filed Jul. 30, 2007, which is herein incorporated by reference.

### FIELD OF INVENTION

The present invention relates to a locking device of an electrical connector. More particularly, the present invention relates to a locking device of a cable end electrical connector.

### DESCRIPTION OF RELATED ART

Refer to FIG. 1, the prior art as Connector in which a locking mechanism is protected as in U.S. Pat. No. 6,945,808 B1, disclosed a connector with containing space 20 on the sides for the locking device 11. The locking device 11, having a spring arm 12, which presses the edge of the containing space 20, locks the coupled electrical device. In this patent, the locking device 11 is cut from a metal plate, and the user's pressing area on the spring arm 12 is the cutting section of the metal plate.

In general, the width of the elastic deformation section of the spring arm 12 is larger than the thickness of the metal plate. Therefore, a user has to apply great stress to deform the spring arm 12 to release the locking device 11 from a locking state to the coupled electrical device.

Besides, the cutting surface of the metal plate is generally sharp, thus the operation in prior art would slash a user's hands by pressing the spring arm.

### SUMMARY

The invention presents a locking device of an electrical connector, wherein the locking device has a deformable spring arm.

The invention presents a locking device of an electrical connector, wherein the electrical connector comprises an insulating housing, a terminal set and a shielding shell. One side of the insulating housing has a containing space for disposing the locking device. The locking device comprises a main body, a locking portion, an operating portion and a spring arm. The main body is itself a unified metal plate, having a pivot hinged in the center for swiveling within limited range with the pivot. The locking portion is applied for buckling to the coupled electrical device. The spring arm presses to the sidewall of the insulating housing to keep the locking device in a stationary position of the locking state. The operating portion provides a user for pressing to release the locking device.

More specified, the spring arm, with planks perpendicular to the main body, extends out from the edge of the main body and is bent from the main body. The spring arm, pressing the insulating housing, retains the locking device in the locking position. The locking portion and the operating portion are at the two ends of the main body respective to the pivot at the locking device's swivel center.

Furthermore, in one embodiment of this invention, the locking device extends out a spring arm between the locking device's swivel center and the locking portion. Thus the range between the spring arm and the swivel center can be shortened to reduce the torque for swiveling the locking device.

### BRIEF DESCRIPTION OF THE DRAWINGS

The invention can be more fully understood by reading the following detailed description of the embodiment, with reference made to the accompanying drawings as follows:

FIG. 1 illustrates a locking device of an electrical connector in prior art.

FIG. 2A illustrates the preferred embodiment with the locking device of an electrical connector of this invention.

FIG. 2B illustrates the preferred embodiment with the locking device of an electrical connector of this invention without a shielding shell.

FIGS. 3A, 3B, 3C and 3D illustrate the preferred embodiments of the locking device of an electrical connector of this invention.

FIGS. 4A and 4B are the motion drawings of the preferred embodiment of the locking device of an electrical connector of this invention.

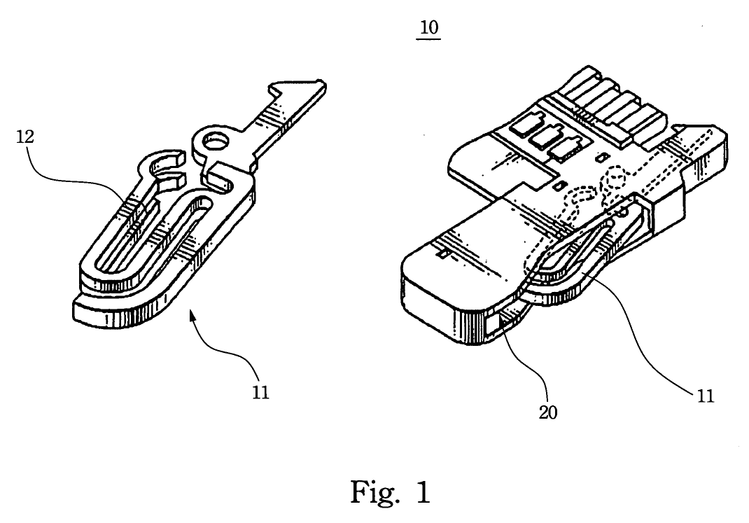

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

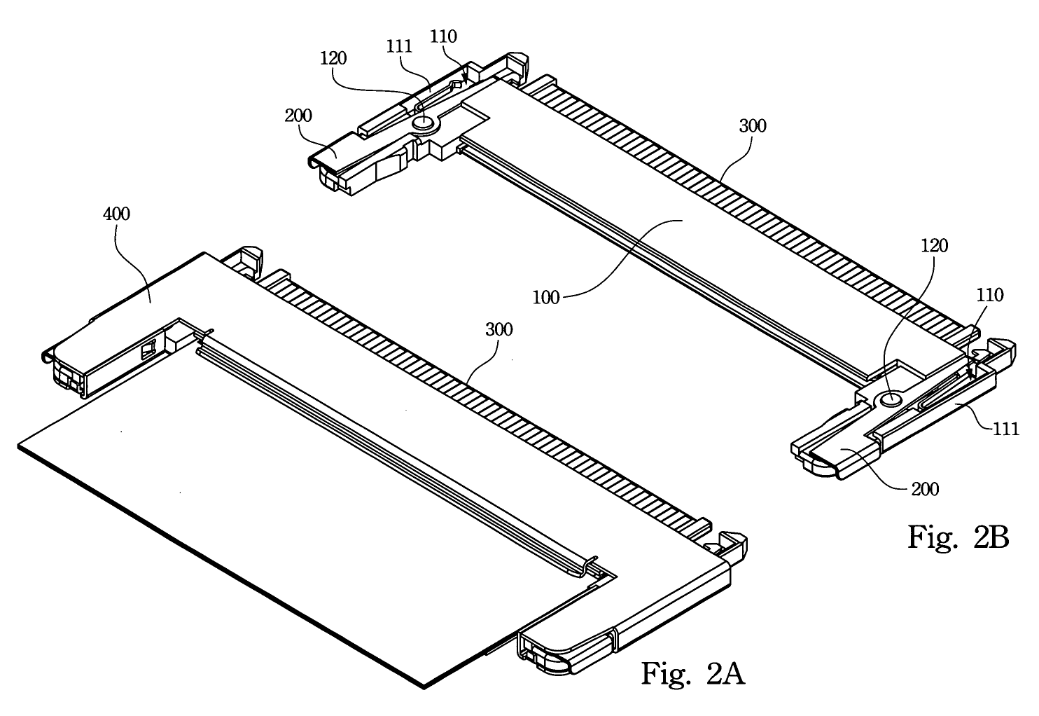

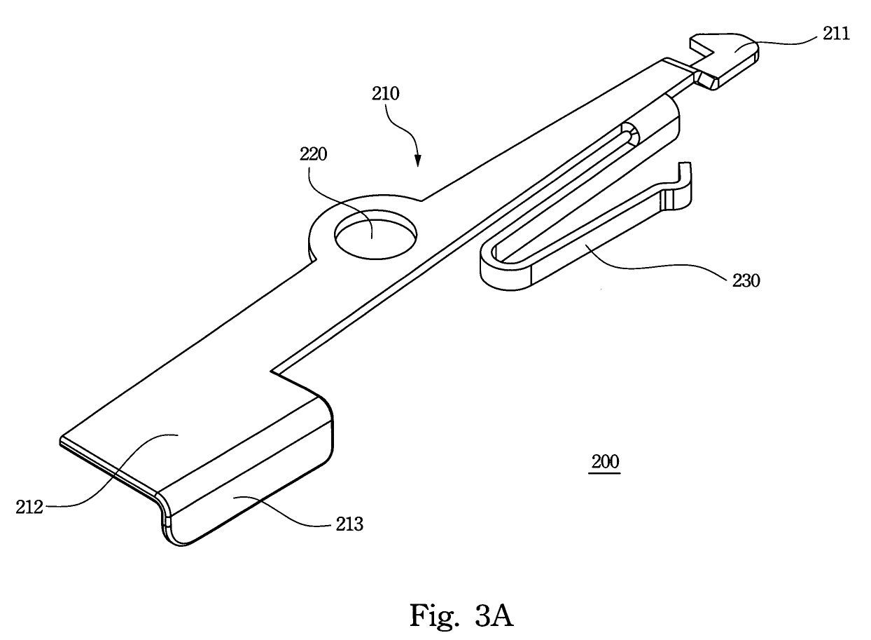

Refer to FIGS. 2A, and 2B. FIG. 2A illustrates the preferred embodiment with the locking device of an electrical connector of this invention, and FIG. 2B illustrates the preferred embodiment with the locking device of an electrical connector of this invention without a shielding shell. The electrical connector of this invention comprises an insulating housing 100, a terminal set 300 and a shielding shell 400. The insulating housing 100 is a container with the containing spaces 110 on both sides in this embodiment. The containing spaces 110 of the preferred embodiment of the invention are confined by the sidewalls 111 and the shielding shell 400, wherein the sidewalls 111 are formed on the both sides of the insulating housing 100. The terminal set 300 is aligned in the insulating housing 100 and within two containing spaces 110. The shielding shell 400, made of metal, covers the insulating housing 100 and the terminal set 300 for shielding the electrical connector. Two pivots 120 are disposed respectively in both containing spaces 110 for pivoting the locking devices 200 in the containing spaces 110.

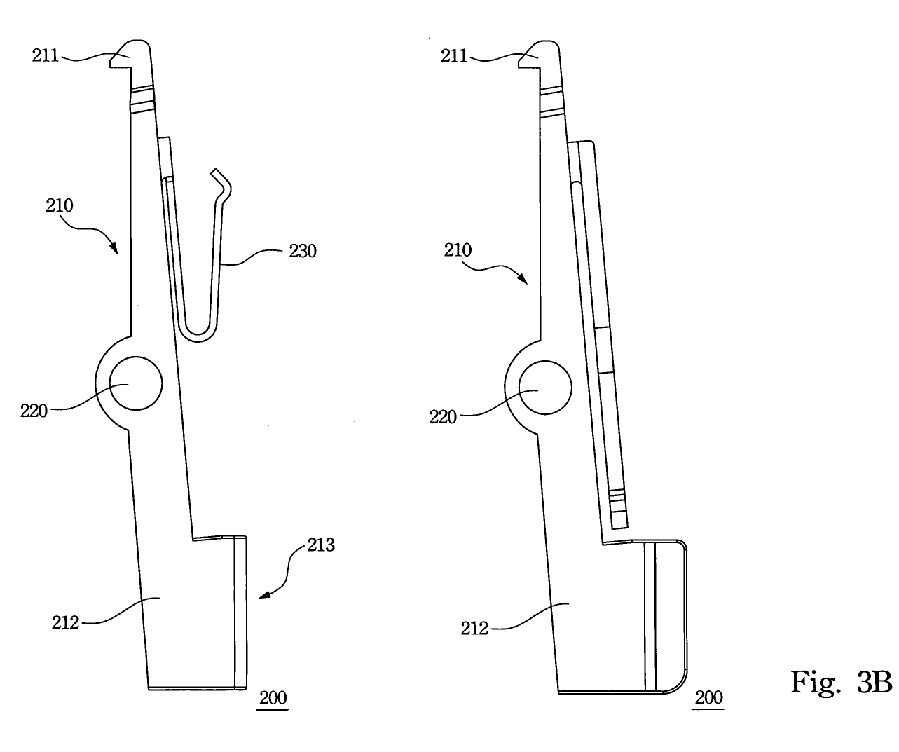

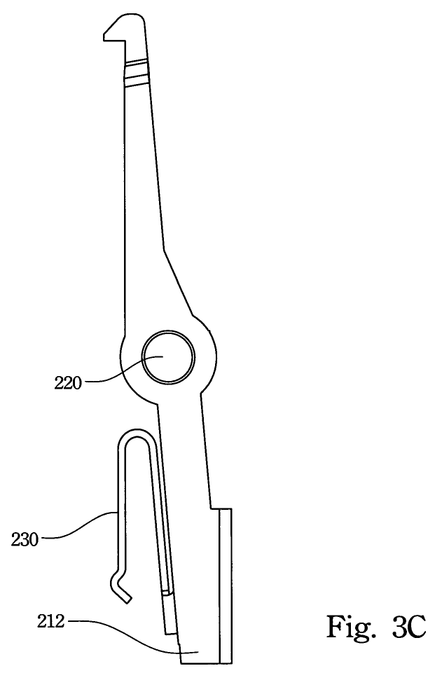

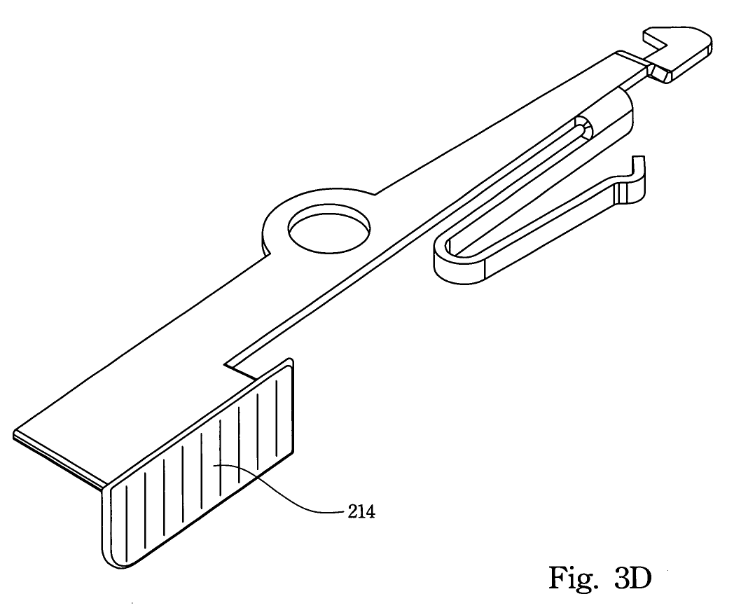

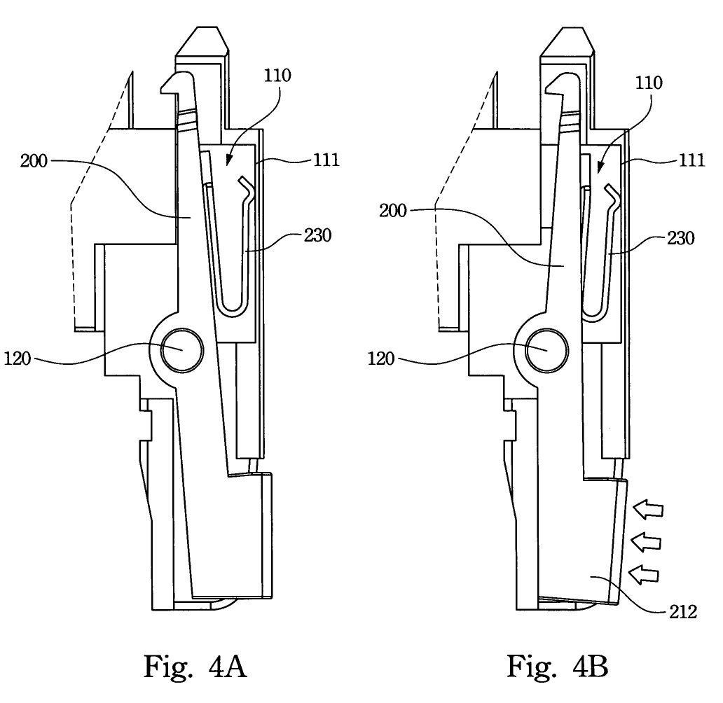

Refer to FIGS. 3A, 3B, 3C and 3D. FIGS. 3A, 3B, 3C and 3D illustrate the preferred embodiments of the locking device of an electrical connector of this invention. Although the insulating housing 100 has two containing spaces 110 enclosing two locking devices 200 on both sides, it would be easier to describe only one locking device 200. So, it will be apparent to those skilled in the art to realize the same structure of the other locking device of this invention. As shown in FIG. 3A, the locking device 200 is applied to lock on or release from the coupled electrical device (not shown in FIG. 3A). The locking device 200 is roughly a long and narrow plate-shaped component and which comprises a main body 210, a locking portion 211, an operating portion 212, a pivot aperture 220, and a spring arm 230. The main body 210 is itself a unified metal plate. The pivot aperture 220 penetrates at the central part on the main body 210, dividing the main body 210 with the locking portion 211 and the operating portion 212. The locking portion 211 is applied for buckling to lock on a coupled electrical device. The operating portion 212 provides a user for pressing to release the locking portion 211 from buckling state. The locking device 200 is equipped within the containing space 110, and through the pivot aperture 220 hinged onto the pivot 120. Therefore, the main body 210 of the locking device 200 is able to swivel within limited range with the pivot 120 as center in the containing space 110. The spring arm 230, bent from the rim of the main body 210, presses to the sidewall 111 of the insulating housing 100 to keep the locking device 200 in a stationary buckling position. The spring arm 230 with planks perpendicular to the main body 210 (as shown in FIGS. 3A and 3B) was bent from the main body 210 which had been cut. In this embodiment, the spring arm 230 is bent with a U-shaped crook for pressing the sidewall 111 of the insulating housing 100. The U-shaped spring arm 230 is possible to exert a pre-loading force toward the sidewall 111 to retain the locking device 200 in a stationary buckling position. The spring arm 230 can be disposed on the main body 210 between the locking portion 211 and the pivot aperture 220, and by pressing the sidewall 111 induces the resilience to retain the locking device 200 in a stationary position. In another embodiment, the spring arm 230 can also be disposed on the main body 210 between the operating portion 212 and the pivot aperture 220 (as shown in FIG. 3C). The pivot aperture 220 in these two embodiments does not superpose with the location of the operating portion 212 or the spring arm 230. Thus the thrust pushing the operating portion 212 and the resilience induced by the spring arm 230 can produce two moments in reverse directions to the center of the pivot aperture 220. Therefore, it is possible to lock the locking device on a coupled electrical device through the resilience induced by the spring arm 230 (as shown in FIGS. 4A and 4B), or, by pushing the operating portion 212 to release the locking device 200 from locking on a coupled electrical device. Moreover, the operating portion 212 can also be bent out with an operating plate 213 from the main body 210 for increasing the pressing area, so that a user will be able pressing softer. Or, the operating portion 212 can be attached a tab on for increasing the pressing area (as shown in FIG. 3D).

Refer to FIGS. 4A, and 4B. FIGS. 4A and 4B are the motion drawings of the preferred embodiment of the locking device of an electrical connector of this invention. The locking device 200 of this invention is retained in locking state through the spring arm 230 pressing to the sidewall 111 of the insulating housing 100 to buckling the coupled electrical device, as shown in FIG. 4A. The locking device 200 of this invention is released by pushing the operating portion 212 to produce a torque contrary to torque induced by the above-mentioned spring arm 230 to unlock from the coupled electrical device, as shown in FIG. 4B.

In conclusion, the locking device of an electrical connector of this invention is superior to prior art with following advantages:

1. The spring arm of the locking device is bent from the main body, and the arm's top plain is perpendicular to the main body's top plain. Therefore the stress pressing toward the sidewall by the spring arm is lower such that it is easier for a user to operate the locking device.

2. The operating portion of the locking device is formed by bending process, thus the direction, pushing toward the operating portion, is parallel to the main body's swiveling direction. Therefore, it is possible to provide a larger area for a user to press, and not cause wounds instead.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A locking device of an electrical connector, wherein the electrical connector has a terminal set inserted in an insulating housing, covered with a shielding shell, has at least a sidewall thereby confining at least a containing space between the sidewall and the shielding shell for accommodating the locking device, wherein the locking device comprises:
a main body, pivotally connected within the containing space by a pivot for being swiveled in the containing space;
a locking portion, at an end of the main body for locking on a coupled electrical device;
a spring arm, bent from the main body with the shape of crooks, wherein the spring arm provides for pressing toward the sidewall of the containing space; and
an operating portion, at the other end of the main body away from the locking portion, whereby pushing the operating portion swivels the main body with the pivot as center.

2. The locking device of claim 1, wherein the locking device is cut from a metal plate and the spring arm is bent perpendicularly from the main body of the locking device.

3. The locking device of claim 2, wherein the spring arm of the locking device has at least a U-shaped crooked portion bent from the main body.

4. The locking device of claim 1, wherein the sidewall is bent from the shielding shell.

5. The locking device of claim 1, wherein the spring arm of the locking device exerts a pre-loading force toward the sidewall of the containing space for keeping the locking portion of the locking device in a stationary position.
